(19) United States
(12) Patent Application Publication
(10) Pub. No.: US 2025/0361136 A1
(43) Pub. Date: Nov. 27, 2025

(54) METHOD FOR OPERATING A FILLING SYSTEM AND FILLING SYSTEM

(71) Applicant: KROHNE Messtechnik GmbH, Duisburg (DE)

(72) Inventors: Dirk KUSCHNERUS, Krefeld (DE); Christopher LUEKE, Gelsenkirchen (DE); Sven WALBRECKER, Wurster Nordseekueste (DE)

(73) Assignee: KROHNE Messtechnik GmbH, Duisburg (DE)

(21) Appl. No.: 19/215,618

(22) Filed: May 22, 2025

(30) Foreign Application Priority Data
May 22, 2024 (DE) 10 2024 001 651.1

(51) Int. Cl. B67D 7/30

(52) U.S. Cl. CPC B67D 7/303

(57) ABSTRACT

A method for operating a filling system for filling a target volume of a first medium is described and shown. The filling system has at least one filling point measuring device, at least one control measuring device and at least one computing unit. The filling point measuring device controls the filling of the target volume, wherein the control measuring device is arranged in the filling system such that it captures the target volume of the medium to be filled which is controlled by the filling point measuring device, and wherein the filling point measuring device and the control measuring device are connected to the computing unit.

This nonprovisional application claims priority under 35 U.S.C. § 119 (a) to German Patent Application No. 10 2024 001 651.1, which was filed in Germany on May 22, 2024, and which is herein incorporated by reference.

### BACKGROUND OF THE INVENTION

### Field of the Invention

The invention is based on a method for operating a filling system for filling a target volume of a first medium, wherein the filling system has at least one filling point measuring device, at least one control measuring device and at least one computing unit, wherein the filling point measuring device controls the filling of the target volume, wherein the control measuring device is arranged in the filling system in such a way that it captures the target volume of the medium to be filled which is controlled by the filling point measuring device, and wherein the filling point measuring device and the control measuring device are connected to the computing unit.

Furthermore, the invention also relates to a filling system for filling a target volume of a first medium, wherein the filling system has at least one filling point measuring device, at least one control measuring device and at least one computing unit, wherein the filling point measuring device controls the filling of the target volume, wherein the control measuring device is arranged in the filling system in such a way that it captures the target volume of the medium to be filled which is controlled by the filling point measuring device, and wherein the filling point measuring device and the control measuring device are connected to the computing unit.

### Description of the Background Art

When it is stated that the filling point measuring device controls the filling of a target volume and that the control measuring device captures the target volume of the medium to be filled that is controlled by the filling point measuring device, this naturally implies that the filling point measuring device is designed to control the target volume in the operating state and that the control measuring device is designed to capture the target volume of the medium to be filled that is controlled by the filling point measuring device in the operating state.

Filling systems which control the filling of a target volume by means of measuring devices, for example by means of flowmeters or level measuring devices, are known from the prior art.

The measuring devices used for control are usually calibrated with a calibration medium, in particular water, before delivery. If the medium to be filled deviates from the calibration medium, the measuring device may exhibit an increased error, i.e. an increased measurement deviation and/or poorer repeatability of the measured values.

A method for filling a medium is known from US 2017/0068257 A1, wherein the parameterization of the filling system is optimized.

### SUMMARY OF THE INVENTION

It is therefore an object of the present invention to provide a method for operating a filling system and a filling system which has a particularly low measurement deviation and/or a particularly good repeatability.

According to a first teaching of the present invention, the object above is achieved by a method, in that the method comprises the following steps: performing a first filling routine, wherein the first filling routine comprises the following method steps: filling a target volume under control of the filling point measuring device, and forwarding a filling point measured value of the filling point measuring device to the computing unit, wherein the filling point measured value correlates with the target volume, or indicating the presence of a filling point measured value of the filling point measuring device in the computing unit, wherein the filling point measured value correlates with the target volume; capturing the filled target volume by the control measuring device; forwarding a control measured value of the control measuring device to the computing unit, wherein the control measured value correlates with the target volume; performing at least one second filling routine, preferably performing a plurality of filling routines, so that at least two filling point measured values of the filling point measuring device and at least two corresponding control measured values are present in the computing unit, preferably wherein a plurality of filling point measured values of the filling point measuring device and a plurality of corresponding control measured values are present in the computing unit; determining a first repeatability of the filling point measuring device by the computing unit from the filling point measured values of the filling point measuring device and the control measured values and evaluating the first repeatability, and if the first repeatability is above a defined limit value: varying at least one parameter or parameter set to control the filling point measuring device, performing at least two further filling routines, wherein the filling point measuring device is controlled with the at least one changed parameter or the changed parameter set, and determining a second repeatability, and/or evaluating the second repeatability by the computing unit as good if the value of the second repeatability is less than the value of the first repeatability or evaluating the second repeatability by the computing unit as poor if the value of the second repeatability is greater than the value of the first repeatability.

According to the invention, it has been recognized that by using a control measuring device before or during the actual filling operation, the repeatability of the filling point measuring device can be optimized by varying at least one parameter or one set of parameters for controlling the filling point measuring device. It has therefore been recognized that the repeatability of the filling station measuring device can be influenced by the parameters for controlling the filling station measuring device. If the filling point measuring device has an improved or optimum repeatability during operation, a systematic deviation when checking the target volume, for example, can be corrected easily and particularly accurately by taking an offset into account. The better the repeatability of the measuring device or the measuring process, the more accurately the offset can be determined. When determining the repeatability according to the invention, the value of the target volume of the first filling routine corresponds to the value of the target volume of the second filling routine or the further filling routines.

For example, the first repeatability of the filling point measuring device can be determined by determining the standard deviation of the control measured values. According to this design, the filling point measured values are discarded for the calculation of the repeatability. For example, the filling point measured values correspond to the specified value of the target volume. The filling point measured values are therefore not real measured values but correspond to the default value of the target volume. In this case, the filling point measured values also have no standard deviation.

In addition, the first repeatability can also be determined by averaging the standard deviation of the filling point measured values and the standard deviation of the control measured values. Furthermore, the first repeatability can also be determined by determining the standard deviation of the filling point measured values and the control measured values.

The optimization routine according to the invention can preferably be integrated into the normal filling operation. In an advantageous manner, the filling system can thus check and optimize the repeatability once or regularly or even irregularly during operation and thus always use the optimum parameters to control the filling point measuring device.

For example, the optimization method according to the invention can be performed whenever there is a change in a process parameter, such as the medium temperature, the medium pressure, the viscosity of the medium, the conductivity of the medium or the type of medium.

If the filling point measuring device used in the method according to the invention is a flowmeter, a parameter to be optimized is, for example, the sensor sampling rate and/or the field frequency and/or the overshoot, i.e. the increase in the voltage at the field coils in the transient phase of the magnetic field, in the case of a magnetic-inductive flowmeter. According to this design, the filling point measured value can be the volumetric flow rate of the medium to be filled.

Alternatively, the filling point measuring device used in the method according to the invention can also be a level measuring device. In this case, a parameter to be optimized is, for example, the radar frequency of a radar level measuring device.

The control measuring device can be designed as a scale, for example. In this case, the control measuring device can check the weight of the filled medium. If the filling point measuring device is designed as a flowmeter, the control measuring device can also be designed as a level measuring device.

The computing unit can be arranged in the filling point measuring device itself or designed as an external computing unit, wherein the external computing unit can optionally also be connected to further filling point measuring devices. The computing unit can also be partially arranged in the filling point measuring device itself and further comprise a central unit which is also designed for communication with further filling point measuring devices.

The computing unit controls the filling station measuring device with parameters and also evaluates both the filling station measured values determined by the filling station measuring device and the control measured values determined by the control measuring device. In addition, the computing unit varies the at least one parameter or the parameter set for controlling the filling station measuring device.

When varying the parameter or the parameter set, the computing unit is guided by the evaluation of the repeatability of this parameter set. If the repeatability of a changed parameter or a changed parameter set is evaluated as good, the computing unit varies the parameter or the parameter set in the same direction. If the repeatability of a changed parameter is rated as poor, the processing unit varies the parameter or parameter set in a different direction and/or changes the parameter or parameter set to be varied.

This optimization routine is preferably performed until an optimum parameter and/or an optimum parameter set for controlling the filling point measuring device is found. The filling point measuring device is then controlled during filling operation with this optimum parameter and/or parameter set. If the optimum parameter and/or optimum parameter set is already achieved after the first or second filling routine, the optimized filling point measuring device is available for filling operation particularly quickly.

When it is stated that the filling point measuring device controls the filling of the target volume, this may mean that, if the filling point measuring device is a flowmeter, the flowmeter, for example, emits a signal to actuate a valve when it has registered that the target volume has flowed through the line monitored by the filling point measuring device.

If the filling point measuring device is designed as a level measuring device, the filling point measuring device can emit a signal to actuate a valve, for example, when it has registered that the target volume to be filled has been reached.

Preferably, the computing unit can vary a parameter or a set of parameters again and determines the repeatability again if the repeatability is assessed as poor and/or the computing unit can compare the second repeatability with the limit value, wherein at least one parameter or one parameter set is varied again and the repeatability is determined and evaluated again, if the second repeatability is above the limit value and/or the repeatability and the corresponding parameter or parameter set for controlling the filling point measuring device can be evaluated as optimum if the value of the repeatability is below the limit value.

The limit value thus defines optimum control of the filling point measuring device, i.e. control with which particularly good repeatability of the filling point measuring device can be ensured.

The limit value can be determined depending on the medium to be filled and/or the type of filling point measuring device and/or the prevailing process conditions.

According to a further advantageous design of the method, the at least one optimum parameter or the optimum parameter set for controlling the filling point measuring device is used during the filling operation.

Furthermore, it is also particularly advantageous if a parameter or a parameter set which is stored in the processing unit as the optimum parameter or as the optimum parameter set for the first medium to be filled is used to perform the first filling routine for controlling the filling point measuring device. According to this design, the method according to the invention can be used to verify whether the parameter stored as optimum or the parameter set stored as optimum is actually optimum, i.e. whether the repeatability determined with this parameter or parameter set is below the limit value.

Also, a further sensor can be provided for measuring a property of the first medium, wherein the sensor determines the property of the first medium prior to the first filling routine and wherein the at least one parameter or the parameter set for controlling the filling point measuring device for performing the first filling routine is selected by the computing unit depending on the measured property of the first medium.

The filling point measuring device can be calibrated with a second medium, for example with water, wherein the first medium and the second medium are different, so that for filling the first medium the filling point measuring device takes into account an offset for checking the target volume, wherein the offset is selected depending on the first medium.

If the filling point measuring device is designed as a flowmeter, the flowmeter always adds an offset to the determined volumetric flow rate, for example, or it always subtracts an offset from the determined volumetric flow rate.

The offset to be taken into account can also be determined as part of the repeatability optimization. If the repeatability of the filling point measuring device is sufficiently good within the scope of the invention, i.e. optimum, the offset can also be determined particularly accurately by specifying the target volume to be filled during the filling operation to the filling point measuring device as the target volume to be checked and then checking by the control measuring device to what extent the volume actually filled deviates from the target volume. The deviation is added to the filling point measuring device as an offset if the actual filled volume is smaller than the target volume or the deviation is subtracted from the filling point measuring device as an offset if the actual filled volume is larger than the target volume.

A method for operating the filling point measuring device optimized in this way ensures that the filling point measuring device has both particularly good repeatability and a particularly small measurement deviation.

The filling system can have a plurality of filling points and a plurality of filling point measuring devices, wherein to at least two filling point measuring devices a control measuring device is assigned, and the at least two filling point measuring devices perform their own optimization of repeatability and thus a determination of an optimum parameter or an optimum parameter set for controlling the filling point measuring devices during filling operation.

Preferably, each of the at least two filling point measuring devices can be assigned its own control measuring device. According to this design, the filling point measuring devices can simultaneously optimize their repeatability.

Further, one control measuring device can be assigned to at least two filling point measuring devices. According to this design, the parameters or the parameter sets for controlling the filling point measuring devices are optimized one after the other.

The filling system can have a plurality of filling points and a plurality of filling point measuring devices, wherein to at least two filling point measuring devices a control measuring device is assigned and wherein the plurality of filling point measuring devices can communicate with each other, wherein one filling point measuring device communicates to the other filling point measuring devices a parameter or a parameter set for control, the repeatability of which is assessed as good, wherein the other filling point measuring devices use this parameter or this parameter set as part of their optimization of the repeatability and/or wherein a filling point measuring device informs the other filling point measuring devices of a parameter or a parameter set for control, the repeatability of which is assessed as poor, wherein the other filling point measuring devices discard this parameter or this parameter set as part of their optimization.

For example, the other filling point measuring devices can use the parameter or parameter set rated as good as a starting value for performing their own repeatability optimization.

The filling system can have a plurality of filling points and a plurality of filling point measuring devices, wherein only a first filling point measuring device is assigned a control measuring device and wherein the first filling point measuring device informs the other filling point measuring devices of the optimum parameter or the optimum parameter set for control, for which the repeatability is below the defined limit value, wherein the other filling point measuring devices are operated with this optimum parameter or with this optimum parameter set during operation of the filling system.

If the optimization of the repeatability is only performed at one filling point, the effort required to optimize the repeatability and thus to optimize the filling system during filling operation is particularly low.

Also, before or after the repeatability optimization, the first filling routine can have a first target volume and the second filling routine can have a second target volume, wherein the second target volume may deviate from the first target volume, wherein the deviation is greater than the measurement deviation of the filling point measuring device, and wherein a synchronization of the filling point measuring device and the control measuring device is affirmed by the computing unit if both the filling point measuring device and the control measuring device forward a measured value to the computing unit within the second filling routine which correlates with the second target volume. Such a method is performed before or after the method according to the invention to optimize repeatability. For example, the method is performed before the determination of the first repeatability or after the determination of the optimum repeatability. With this design of the method, it can be ensured that the control measuring device controls the filling point measuring device associated with the control measuring device.

The first filling routine may already have a target volume corresponding to overfilling or underfilling of the container into which the target volume is filled, wherein synchronization of the filling point measuring device and the control measuring device is affirmed by the computing unit when both the filling point measuring device and the control measuring device forward the value of the overfilling or underfilling to the computing unit. Such a method can be performed before or after the method according to the invention to optimize repeatability. In addition, the aforementioned method for synchronizing the filling point measuring device and the control measuring device can also be integrated into the optimization method. In this case, the target volume corresponds to overfilling or underfilling of the container.

This ensures that the target volume deviates by a value that is greater than the measurement deviation of the filling point measuring device from the target volume to be filled in the filling operation, which is also usually used during repeatability optimization, so that the control measuring device actually monitors the associated filling point measuring device.

If the measured values of the filling point measuring device and the control measuring device differ, the control measuring device is not correctly assigned to the filling point measuring device.

If the container is overfilled to ensure the correct assignment of a control measuring device, no waste is produced in an advantageous manner.

The object is also achieved by a filling system in that the computing unit, the at least one filling point measuring device and/or the control measuring device can be designed to perform one of the methods described above.

With regard to the special designs of the filling system, reference is made to the above description of the individual designs of the methods for operating the filling system.

In detail, there are now a large number of possibilities for designing and further developing the method for operating a filling system and the filling system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a method for operating a filling system,

FIG. 2 shows an example of a method for operating a filling system,

FIG. 3 shows an example of a method for operating a filling system,

FIG. 4 shows an example of a method for operating a filling system,

FIG. 5 shows an example of a method for operating a filling system,

FIG. 6 shows an example of a filling system,

FIG. 7 shows an example of a filling system, and

FIG. 8 shows an example of a filling system.

### DETAILED DESCRIPTION

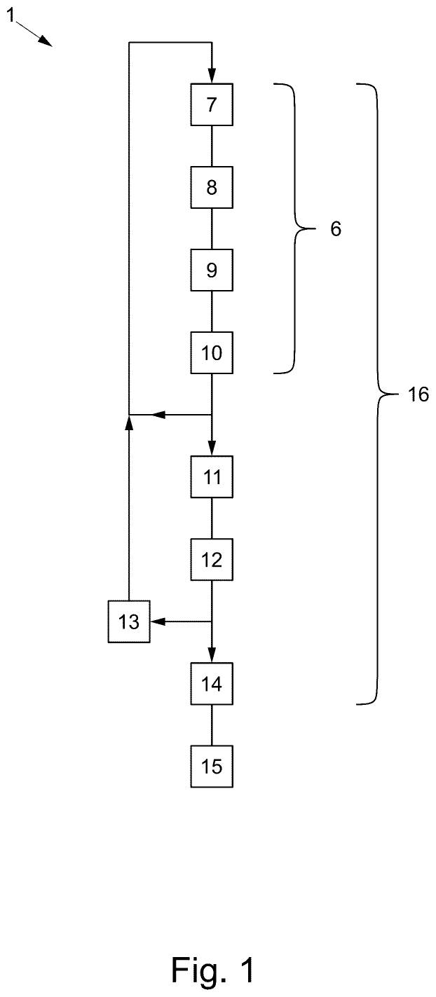

FIG. 1 shows a method 1 for operating a filling system 2, wherein the filling system 2 is designed for filling a target volume of a first medium, wherein the filling system 2 has at least one filling point measuring device 3, at least one control measuring device 4 and at least one computing unit 5. The computing unit may include a processor, memory, and/or display, or may be a prog.

The filling point measuring device 3 controls the filling of the target volume during operation. In the example shown, the filling point measuring device 3 is designed as a flowmeter.

The control measuring device 4 is designed as a level measuring device and is arranged in the filling system 2 in such a way that it captures the target volume of the medium to be filled, which is controlled by the filling point measuring device 3. Furthermore, the filling point measuring device 3 and the control measuring device 4 are connected to the computing unit 5.

In a first part of the method according to the invention, a filling routine 6 is performed, which comprises the following steps:
a. filling 7 a target volume under the control of the filling point measuring device 3,
b. forwarding 8 a filling point measured value of the filling point measuring device to the computing unit, wherein the filling point measured value correlates with the target volume, or indicating the presence of a filling point measured value of the filling point measuring device in the computing unit, wherein the first measured value correlates with the target volume,
c. capturing 9 the filled target volume by the control measuring device 4,
d. forwarding 10 a control measured value of the control measuring device to the computing unit, wherein the control measured value correlates with the target volume.

Subsequently, at least a second filling routine 6, preferably a plurality of filling routines 6, is performed, so that at least two filling point measured values of the filling point measuring device 3 and at least two corresponding control measured values 4 are present in the computing unit 5, preferably wherein a plurality of filling point measured values of the filling point measuring device 3 and a plurality of corresponding control measured values are present in the computing unit 5.

A first repeatability of the filling point measuring device 3 is determined 11 and evaluated 12 by the computing unit 5 from the filling point measuring values of the filling point measuring device 3 and the control measuring values.

If the first repeatability is above a specified limit value, the computing unit 5 varies 13 at least one parameter or one parameter set for controlling the filling point measuring device 3.

Then at least two further filling routines 6 are performed, wherein the filling point measuring device 3 is controlled with the at least one changed parameter and a second repeatability is determined 11.

In a next step, the second repeatability is evaluated 12 by the computing unit.

The second repeatability is evaluated as good if the value of the second repeatability is less than the value of the first repeatability. The second repeatability is evaluated as poor if the value of the second repeatability is greater than the value of the first repeatability.

A plurality of filling routines with a determination of repeatability are performed until the determined repeatability is below a specified limit value.

The at least one parameter or the parameter set for controlling the filling point measuring device, which correlates with the repeatability that is below the specified limit value, is used 14 to control the filling point measuring device during filling operation 19.

Optimizing repeatability thus ensures that the filling point measuring device 3 is operated under the given process conditions in such an optimum manner that the filling point measuring device 3 outputs particularly repeatable measured values.

If the filling point measuring device 3 is calibrated with a second medium, an offset must be added to or subtracted from the determined filling point measured values during regular filling operation 19. With the help of the target volume determined by the control measuring device, the offset to the target volume can then be determined particularly accurately 15 if the repeatability is particularly low.

The method 1 shown has the advantage that, on the one hand, the repeatability of the filling point measuring device is optimized within the scope of the present process conditions and, on the other hand, the measurement deviation of the filling point measuring device is also improved overall by a particularly accurate determination of the offset to be taken into account for checking the medium to be filled.

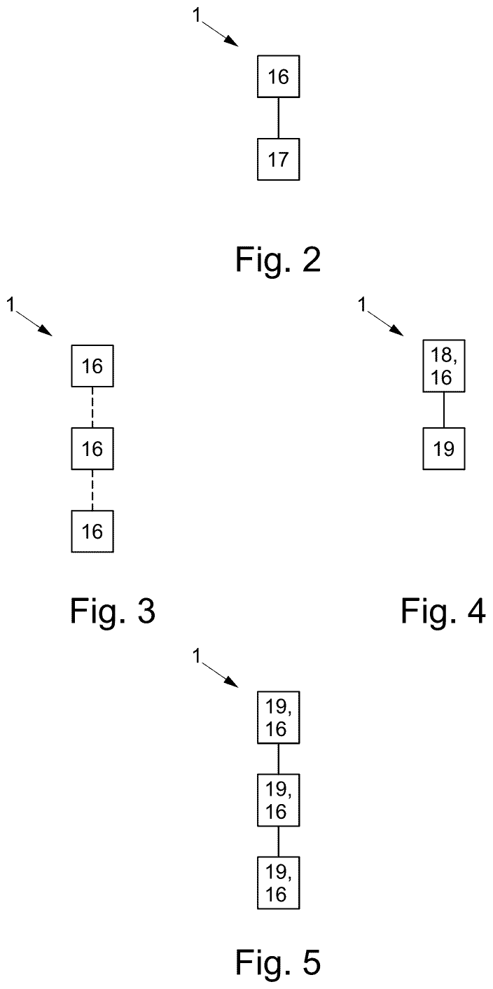

FIG. 2 shows an example of the method 1 according to the invention. In the example shown, a plurality of filling point measuring devices 3 are present. The plurality of filling point measuring devices 3 can either communicate directly with each other or a central processing unit 5 is present which can communicate with all filling point measuring devices 3.

In a first step of the method, the routine 16 described in FIG. 1 is performed at a first filling point measuring device to optimize repeatability and, in this respect, to optimize the parameters for controlling the filling point measuring device.

The filling point measuring device 3 then communicates these optimized parameters to the other filling point measuring devices 3 directly or via the central processing unit 5 with 17 so that the other filling point measuring devices 3 are also operated with the optimized parameters.

According to this design of method 1, the plurality of filling point measuring devices 3 are operated with the same parameters for controlling the filling point measuring devices 3.

This method 1 has the advantage that the filling system 2 can be optimized with little effort at a plurality of filling points, in particular at all filling points.

FIG. 3 shows an example of the method 1 according to the invention. In the method 1 shown in FIG. 3, the filling system 2 also has a plurality of filling points.

In contrast to the method shown in FIG. 2, the routine 16 described in FIG. 1 for optimizing the repeatability or for optimizing the parameters for controlling the filling point measuring device 3 is performed separately at the individual filling points.

For this, each of the plurality of filling point measuring devices 3 is assigned its own control measuring device 4, or there is one control measuring device 4 that is assigned to the plurality of filling point measuring devices 3. According to the last alternative, the repeatability is optimized at the individual filling points one after the other.

According to this example, the individual filling point measuring devices 3 are operated with parameters that have been evaluated as optimum for the respective filling point. In this respect, the individual filling point measuring devices 3 can certainly be operated with different parameters.

FIG. 4 shows an example of the method 1 according to the invention. In a first step, the optimization routine 16 shown in FIG. 1 is performed on a filling point measuring device 3 in a learning phase 18 until the optimum parameters for controlling the filling point measuring device are found.

The filling point measuring device is then controlled with the optimum parameters during normal filling operation 19 without any further checking or re-optimization of the repeatability being performed continuously or regularly. In the example shown, the control measuring device is no longer required for normal filling operation 19.

A new learning phase 18 can be performed before a new filling operation 19, for example if the filling system 2 has been cleaned or a new medium is being filled.

FIG. 5 shows an example of a method 1 according to the invention. According to the example shown, the optimization routine 16 for optimizing the repeatability or for optimizing the parameters for controlling the filling point measuring device is integrated into the regular filling operation 19.

In this respect, the target volume in the optimization routine corresponds to the filling volume during the regular filling process. At regular or irregular intervals, the control measuring device 4 checks the filled target volume and optimum repeatability is determined again according to the method described in FIG. 1. If the parameters for controlling the filling point measuring device 3 deviate from the parameters currently in use, the newly determined parameters are used to control the filling point measuring device 3 in the next filling phase.

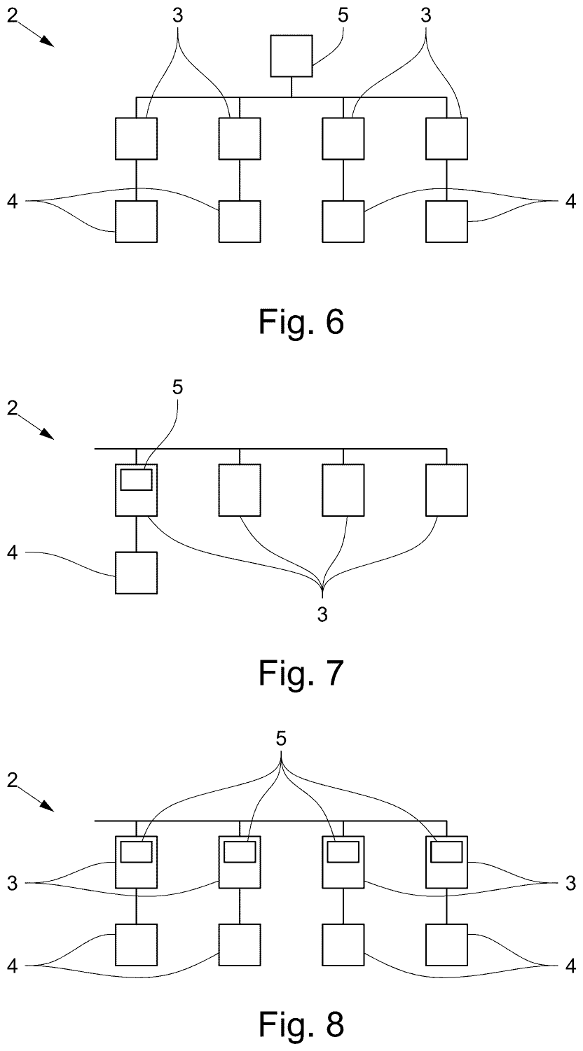

FIG. 6 schematically shows an example of a filling system 2 for filling a target volume of a first medium, wherein the filling system 2 has a plurality of filling point measuring devices 3 and a plurality of control measuring devices 4. Each filling point measuring device 3 is assigned a control measuring device 4, wherein each control measuring device 4 can check the target volume filled by the filling point measuring device 3.

Furthermore, a central computing unit 5 is provided, which can communicate with the individual filling point measuring devices 3.

At the individual filling points, the repeatability and thus the parameters for controlling the filling point measuring devices can be optimized separately. For this purpose, each filling point measuring device has its own computing unit in addition to the central computing unit. This can be done either before normal filling operation 19 in a learning phase or at regular or irregular intervals during normal filling operation.

If the repeatability at a filling point is rated as good or even optimum, the filling point measuring device 3 can communicate this information and/or the corresponding parameters for controlling the filling point measuring device 3 to the central computing unit 5 so that it can communicate the parameters rated as good or optimum for controlling the filling point measuring device 3 to the other filling point measuring devices 3. The other filling point measuring devices 3 use this information in their own optimization routine.

Similarly, a filling point measuring device 3 can inform the central computing unit 5 if repeatability is rated as poor, which can also be used by the other filling point measuring devices 3 in that the filling point measuring devices 3 reject these parameters for control during their optimization routine 16.

FIG. 7 shows an example of a filling system 2 with a plurality of filling point measuring devices 3, wherein, however, only one control measuring device 4 is provided, which is assigned to a filling point measuring device 3. This filling point measuring device 3 also has a computing unit 5 for performing the optimization routine 16 for optimizing repeatability.

The optimization routine 16 is performed at the filling point at which the control measuring device 4 is arranged. If the repeatability is below a specified limit value, the filling point measuring device 3 communicates the optimum parameters for controlling the filling point measuring devices 3 to the other filling point measuring devices 3.

During operation, the one filling point measuring device 3 can perform the optimization routine 16, which includes varying the parameters for controlling the filling point measuring device 3, again at regular or irregular intervals or when a process parameter changes, so that it can always be guaranteed that the filling system 2 or the individual filling point measuring devices 3 are operated with optimum parameters.

FIG. 8 shows an example of a filling system 2 with a plurality of filling point measuring devices 3, wherein each filling point measuring device 3 is assigned a control measuring device 4 and wherein each filling point measuring device 3 has a computing unit 5 which is designed to perform the optimization routine 16 according to the invention for optimizing the repeatability of the respective filling point measuring device 3.

According to this design, the repeatability can be optimized separately at each filling point, either at different times or simultaneously. In this respect, the filling point measuring devices 3 can also be controlled with different parameters so that it can be ensured that the filling point measuring devices 3 are optimized for the filling point relevant to them.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a filling system for filling a target volume of a first medium, the filling system comprising has at least one filling point measuring device, at least one control measuring device and at least one computing unit, the filling point measuring device controls the filling of the target volume, the control measuring device is arranged in the filling system such that it captures the target volume of the medium to be filled which is controlled by the filling point measuring device, and the filling point measuring device and the control measuring device are connected to the computing unit, the method comprising:
performing a first filling routine that comprises:
filling a target volume under control of the filling point measuring device;
forwarding a filling point measured value of the filling point measuring device, the filling point measured value correlating with the target volume, to the computing unit or indicating a presence of a filling point measured value of the filling point measuring device in the computing unit, wherein the filling point measured value correlates with the target volume;
capturing the filled target volume by the control measuring device; and
forwarding a control measured value of the control measuring device to the computing unit, wherein the control measured value correlates with the target volume;
performing at least a second filling routine or a plurality of filling routines such that at least two filling point measured values of the filling point measuring device and at least two corresponding control measured values are present in the computing unit, a plurality of filling point measured values of the filling point measuring device and a plurality of corresponding control measured values being present in the computing unit; and
determining a first repeatability of the filling point measuring device by the computing unit from the filling point measured values of the filling point measuring device and the control measured values and evaluating the first repeatability, wherein if the first repeatability is above a defined limit value:
varying at least one parameter or a parameter set for controlling the filling point measuring device;
performing at least two further filling routines, wherein the filling point measuring device is controlled with the at least one changed parameter or the changed parameter set and determining a second repeatability; and
evaluating the second repeatability by the computing unit as good if the value of the second repeatability is smaller than the value of the first repeatability or evaluating the second repeatability by the computing unit as poor if the value of the second repeatability is greater than the value of the first repeatability.

2. The method according to claim 1, wherein the calculation unit again varies a parameter or a parameter set and again determines the repeatability if the repeatability is assessed as poor, and/or wherein the second repeatability is compared with the limit value and at least one parameter or one parameter set is varied again and that the repeatability is determined and evaluated again, provided that the second repeatability is above the limit value, and/or wherein the repeatability and the corresponding parameter or parameter set for controlling the filling point measuring device are evaluated as optimum if the value of the repeatability is below the limit value.

3. The method according to claim 1, wherein the at least one optimum parameter or the optimum parameter set is used to control the filling point measuring device during the filling operation.

4. The method according to claim 1, wherein a parameter or a parameter set is used to perform the first filling routine to control the filling point measuring device, which parameter or parameter set is stored in the computing unit as an optimum parameter or as an optimum parameter set for the first medium to be filled.

5. The method according to claim 1, wherein a further sensor is present for measuring a property of the first medium, and wherein the sensor determines the property of the first medium before the first filling routine, and wherein the at least one parameter or the parameter set for controlling the filling point measuring device for performing the first filling routine is selected by the computing unit depending on the measured property of the first medium.

6. The method according to claim 1, wherein the filling point measuring device is calibrated with a second medium, wherein the first medium and the second medium are different, and wherein, when the first medium is filled, the filling point measuring device takes an offset into account in order to control the target volume, the offset being selected depending on the first medium.

7. The method according to claim 1, wherein the filling system comprises a plurality of filling points and a plurality of filling point measuring devices, wherein, to at least two filling point measuring devices, a control measuring device is assigned, and wherein the at least two filling point measuring devices perform their own optimization of the repeatability and thus a determination of an optimum parameter or an optimum parameter set for controlling the filling point measuring devices during the filling operation.

8. The method according to claim 1, wherein the filling system comprises a plurality of filling points and a plurality of filling point measuring devices, wherein at least two filling point measuring devices are assigned a control measuring device, and wherein the plurality of filling point measuring devices are adapted to communicate with one another, wherein a filling point measuring device communicates to the other filling point measuring devices a parameter or a parameter set for control, the repeatability of which is assessed as good, wherein the other filling point measuring devices use this parameter or this parameter set as part of their optimization of the repeatability and/or wherein a filling point measuring device communicates to the other filling point measuring devices a parameter or a parameter set for control whose repeatability is assessed as poor, wherein the other filling point measuring devices discard this parameter or this parameter set as part of their optimization.

9. The method according to claim 1, wherein the filling system comprises a plurality of filling points and a plurality of filling point measuring devices, wherein a control measuring device is assigned to only a first filling point measuring device, and wherein the first filling point measuring device communicates the optimum parameter or the optimum parameter set to the other filling point measuring devices for actuation, for which the repeatability is below the specified limit value, and wherein the other filling point measuring devices are operated with this optimum parameter or with this optimum parameter set during filling operation.

10. The method according to claim 1, wherein, before or after the repeatability optimization, the first filling routine has a first target volume and the second filling routine has a second target volume, wherein the second target volume deviates from the first target volume, wherein the deviation is greater than the measurement deviation of the filling point measuring device, and wherein a synchronization of the filling point measuring device and of the control measuring device is affirmed by the computing unit if both the filling point measuring device and the control measuring device forward a measured value to the computing unit within the framework of the second filling routine, which measured value correlates with the second target volume.

11. A filling system for filling a target volume of a first medium, wherein the filling system comprises:
at least one filling point measuring device;
at least one control measuring device; and
at least one computing unit,
wherein the filling point measuring device controls the filling of the target volume,
wherein the control measuring device is arranged in the filling system such that it captures the target volume of the medium to be filled which is controlled by the filling point measuring device, and
wherein the filling point measuring device and the control measuring device are connected to the computing unit, and
wherein the computing unit, the at least one filling point measuring device, and the control measuring device are designed to perform the method according to claim 1.
